(19) United States
(12) Patent Application Publication
(10) Pub. No.: US 2025/0007308 A1
(43) Pub. Date: Jan. 2, 2025

(54) METHOD AND DEVICE FOR SCHEDULING CHARGING

(71) Applicant: ASUSTeK COMPUTER INC., Taipei City (TW)

(72) Inventors: Tse-Chih Lin, Taipei City (TW); Yun-Hsuan Lee, Taipei City (TW); Shu-Hong Yeh, Taipei City (TW)

(73) Assignee: ASUSTeK COMPUTER INC., Taipei City (TW)

(21) Appl. No.: 18/342,740

(22) Filed: Jun. 28, 2023

(51) Int. Cl. H02J 7/00

(52) U.S. Cl. CPC H02J 7/0071; H02J 7/00032

(57) ABSTRACT

A method and a device for scheduling charging. The method includes the following steps: multiple charging records are collected; multiple charging time data of the charging records of which charging duration is within a predetermined time range is extracted from the collected charging records; and the charging time data is analyzed by using a way of weight point to obtain a suggestion charging period.

### BACKGROUND

### Technical Field

The disclosure relates to a method and a device for scheduling charging that are capable of protecting a battery.

### Description of Related Art

Most of today's handheld electronic products (such as notebook computers, mobile phones, digital cameras, and tablet computers) are equipped with rechargeable batteries. Generally, the battery may be charged as long as a power adapter (for example, an alternating current (AC) adapter) is plugged into the electronic product. However, after plugging the power adapter into the electronic product, a user usually does not pay attention to the charging time. Even if the battery is fully charged, the user does not immediately unplug the power adapter. In this way, the battery continues to be fully charged, which easily causes damage to the battery and reduce the service life of the battery.

### SUMMARY

This disclosure provides a method for scheduling charging, which includes the following steps: multiple charging records are collected; multiple charging time data of the charging records of which charging duration is within a predetermined time range is extracted from the collected charging records; and the charging time data is analyzed by using a way of weight point to obtain a suggestion charging period.

The disclosure further provides a device for scheduling charging, which includes a memory and a processor. The memory stores a module group. The processor is coupled to the memory, and loads and executes the module group stored in the memory to collect multiple charging records; extract multiple charging time data of the charging records of which charging duration is within a predetermined time range from the collected charging records; and analyze the charging time data by the way of weight point to obtain the suggestion charging period.

Based on the above, the method and the device for scheduling charging of the disclosure can collect the charging records of the user, analyze the charging habits of the user, and accurately predict the suggestion charging period suitable for the user. In this way, when charging is performed during the scheduling suggestion charging period, the charging intensity can be dynamically adjusted to prevent the battery from maintaining the full charging state for a long time, thereby preventing damage to the battery and increasing the service life of the battery.

In order to make the aforementioned features and advantages of the disclosure comprehensible, embodiments accompanied with drawings are described in detail as follows.

### BRIEF DESCRIPTION OF THE DRAWINGS

FIG. 1 is a schematic block diagram of a device for scheduling charging according to an embodiment of the disclosure.

FIG. 2 is a schematic structural diagram of a module group stored in a memory according to an embodiment of the disclosure.

FIG. 3 is a flowchart of a method for scheduling charging according to an embodiment of the disclosure.

FIGS. 4A and 4B are flowcharts of a method for scheduling charging according to an embodiment of the disclosure.

FIG. 5 is an example of notification screens according to an embodiment of the disclosure.

### DESCRIPTION OF THE EMBODIMENTS

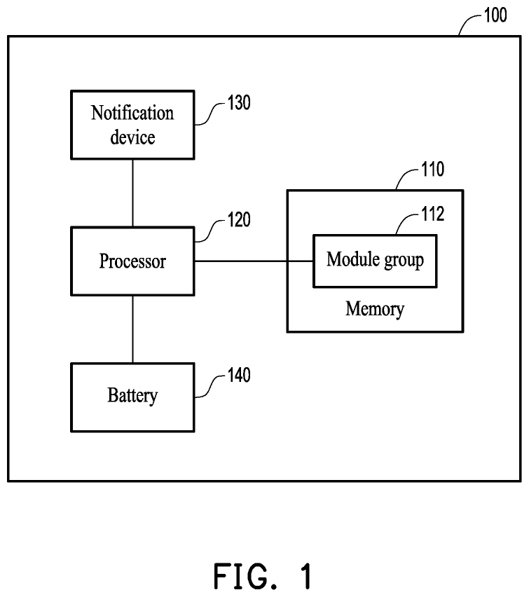

Referring to FIG. 1, a device 100 for scheduling charging of the embodiment is an electronic device such as a notebook computer, a mobile phone, a digital camera or a tablet computer, and includes a memory 110, a processor 120, a notification device 130 and a battery 140.

The memory 110 is configured to store a module group 112 including data, a program code and a combination thereof. The memory 110 may be, for example, any type of fixed or removable random access memory (RAM), read-only memory (ROM), flash memory, hard disk or other similar devices, integrated circuits and a combination thereof.

The processor 120 is, for example, a central processing unit (CPU), or other programmable general purpose or special purpose microprocessors, digital signal processors (DSPs), programmable controllers, application specific integrated circuits (ASICs) or other similar elements or a combination thereof.

The notification device 130 is, for example, a display using a liquid crystal display (LCD), a light-emitting diode (LED), a field emission display (FED) or other types of panels. The notification device 130 may be configured to display a notification screen (including a message or a window) to deliver a message or any information to the user. However, in another embodiment, the notification device 130 may also be, for example, a loudspeaker, which may play a sound to deliver a message to the user, and the disclosure is not limited thereto.

The battery 140 may be configured to supply power to the device 100 for scheduling charging, and may be built-in or external. The battery 140 includes, for example, a battery pack and a control circuit. The battery pack is composed, for example, of one or more battery cells. The control circuit includes, for example, a battery gauge IC, which may calculate the remaining power and the charging and discharging current of the battery 140.

As shown in FIG. 1, the processor 120 is coupled to the memory 110, the notification device 130 and the battery 140. The processor 120 may load and execute the stored module group 112 from the memory 110 to execute the method for scheduling charging of the disclosure.

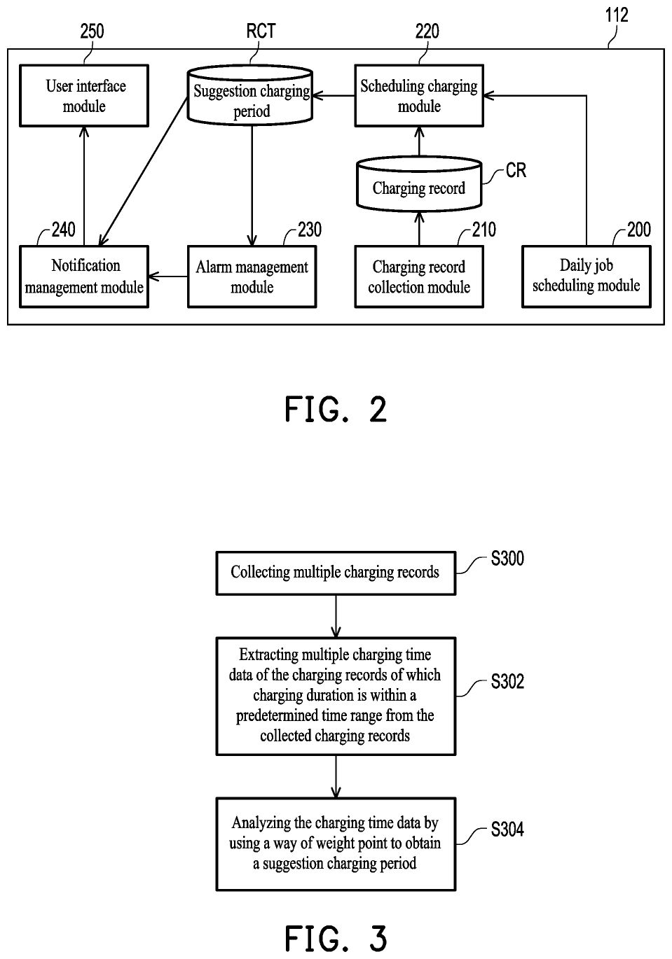

In FIG. 2, the structure of the module group 112 stored in the memory 110 is illustrated. The module group 112 includes a daily job scheduling module 200, a charging record collection module 210, a scheduling charging module 220, an alarm management module 230, a notification management module 240 and a user interface module 250. The daily job scheduling module 200 has a timing function, which may trigger the execution of the scheduling charging module 220 at a fixed time every day. The charging record collection module 210 may collect a daily charging record CR, and provide the charging record CR to the scheduling charging module 220 for use. The scheduling charging module 220 may extract the charging time data of the charging records CR of which charging duration is within a predetermined time range from the collected charging records CR, and analyze the charging time data by using a way of weight point to obtain a suggestion charging period RCT. For the detailed actions performed by the scheduling charging module 220, please refer to the method for scheduling charging described later.

The suggestion charging period RCT may be, for example, stored in a corresponding data base. The alarm management module 230 may set an alarm time according to the suggestion charging period RCT. In the embodiment, the suggestion charging period RCT includes a suggestion start charging hour and a suggestion end charging hour, and the suggestion charging period RCT is equal to a time period between the suggestion start charging hour and the suggestion end charging hour. The alarm time may be set, for example, at a time before a first predetermined time (for example, half an hour) of the suggestion start charging hour. When the alarm time is reached every day, the alarm management module 230 may trigger the notification management module 240 to obtain the latest suggestion charging period RCT from the data base, and use the notification device 130 to notify the user of the suggestion charging period RCT through the user interface module 250.

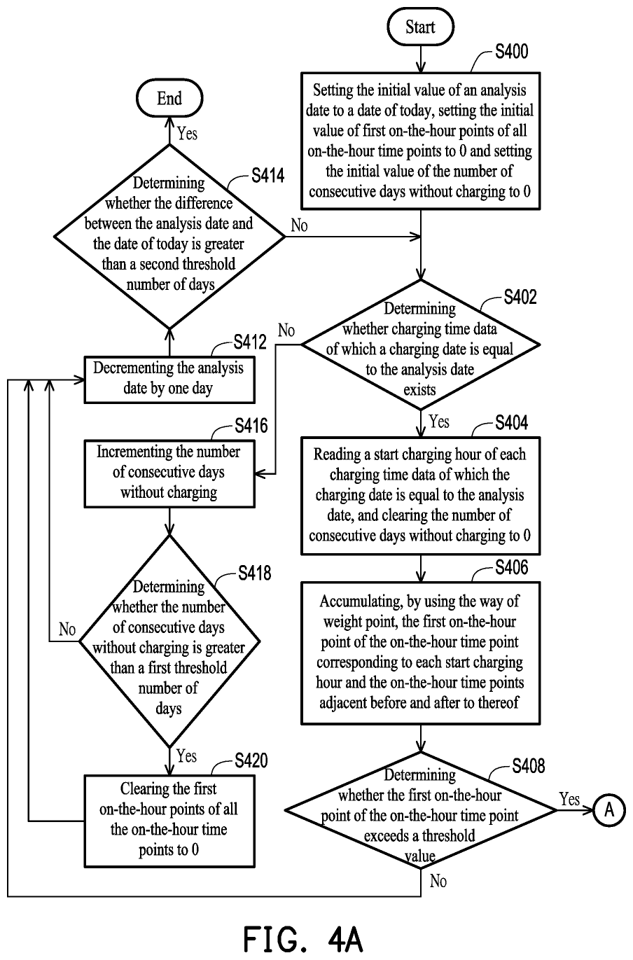

The following embodiment illustrates the detailed steps of the method for scheduling charging of the disclosure. Please refer to FIG. 1 and FIG. 3 at the same time. The method of the embodiment is adapted for the device 100 for scheduling charging of FIG. 1, and the steps are described as follows.

First, in step S300, the processor 120 collects multiple charging records CR. For example, each charging record CR at least includes a charging date, a start charging time and an end charging time. Every day when the power adapter is plugged into the device 100 for scheduling charging, the processor 120 may record the charging date and the start charging time. When the power adapter is unplugged from the device 100 for scheduling charging, the processor 120 may record the end charging time. For example, the processor 120 starts to execute the following algorithm to obtain the suggestion charging period RCT after collecting the charging records CR for at least five days.

Next, in step S302, the processor 120 extracts multiple charging time data of the charging records CR of which charging duration is within a predetermined time range from the collected charging records CR. For example, the processor 120 may calculate the corresponding charging duration according to the start charging time and the end charging time of each charging record CR, and ignore the charging record CR of which the charging duration is too long or too short, so as to extract the charging time data of the charging record CR of which the charging duration is within the predetermined time range. Each charging time data at least includes a charging date, a start charging hour and an end charging hour. It should be noted that in the embodiment, a total of 24 on-the-hour time points are established by using 0:00, 1:00, 2:00, . . . 23:00 of a day (that is, a day includes 24 on-the-hour time points), and the range of half an hour before and after the hour is used to decide which on-the-hour time point the charging moment belongs to. For example, if the start charging time of a charging record CR is 11:12, then the start charging hour of the charging time data is 11:00, and if the end charging time of a charging record CR is 23:47, then the end charging hour of the charging time data thereof is 0:00, and so on.

Finally, in step S304, the processor 120 analyzes the charging time data by using the way of weight point to obtain the suggestion charging period RCT. Specifically, the processor 120 may accumulate a first on-the-hour point of the on-the-hour time point corresponding to the start charging hour of each charging time data by using the way of weight point according to the charging date and the start charging hour of each charging time data, and take the on-the-hour time point at which the first on-the-hour point is the highest as the suggestion start charging hour. In addition, the processor 120 may accumulate a second on-the-hour point of the on-the-hour time point corresponding to the end charging hour of each charging time data by using the way of weight point according to the charging date, the start charging hour and the end charging hour of each charging time data, and take the on-the-hour time point at which the second on-the-hour point is the highest as the suggestion end charging hour. In the embodiment, each of the 24 on-the-hour time points has the first on-the-hour point for determining the suggestion start charging hour and the second on-the-hour point for determining the suggestion end charging hour, and the first on-the-hour point and the second on-the-hour point are independent of each other.

Furthermore, the processor 120 may accumulate a first score (for example, 2 points) for the first on-the-hour point of the on-the-hour time point corresponding to the start charging hour of each charging time data, and accumulate a second score (for example, 1 point) that is smaller than the first score for the first on-the-hour points of the on-the-hour time points adjacent before and after to the on-the-hour time point corresponding to the start charging hour of each charging time data. For example, if the start charging hour of charging time data is 11 o'clock, then the first on-the-hour point of 11 o'clock accumulates 2 points, and the first on-the-hour points of 10 o'clock and 12 o'clock accumulate 1 point. When the start charging hour is 0 o'clock, the first on-the-hour point of 0:00 accumulates 2 points, the first on-the-hour points of 23:00 and 1:00 accumulate 1 point, and so on.

Similarly, the processor 120 may accumulate the first score (for example, 2 points) for the second on-the-hour point of the on-the-hour time point corresponding to the end charging hour of each charging time data, and accumulate the second score (for example, 1 point) that is smaller than the first score for the second on-the-hour points of the on-the-hour time points adjacent before and after to the on-the-hour time point corresponding to the end charging hour of each charging time data. For example, if the end charging hour of charging time data is 11 o'clock, then the second on-the-hour point of 11 o'clock accumulates 2 points, and the second on-the-hour points of 10 o'clock and 12 o'clock accumulate 1 point. When the charging hour is 0 o'clock, the second on-the-hour point of 0:00 accumulates 2 points, the second on-the-hour points of 23:00 and 1:00 accumulate 1 point, and so on. In this way, the processor 120 may take the on-the-hour time point at which the first on-the-hour point is the highest as the suggestion start charging hour, and the on-the-hour time point at which the second on-the-hour point is the highest as the suggestion end charging hour, so as to obtain the suggestion charging period RCT.

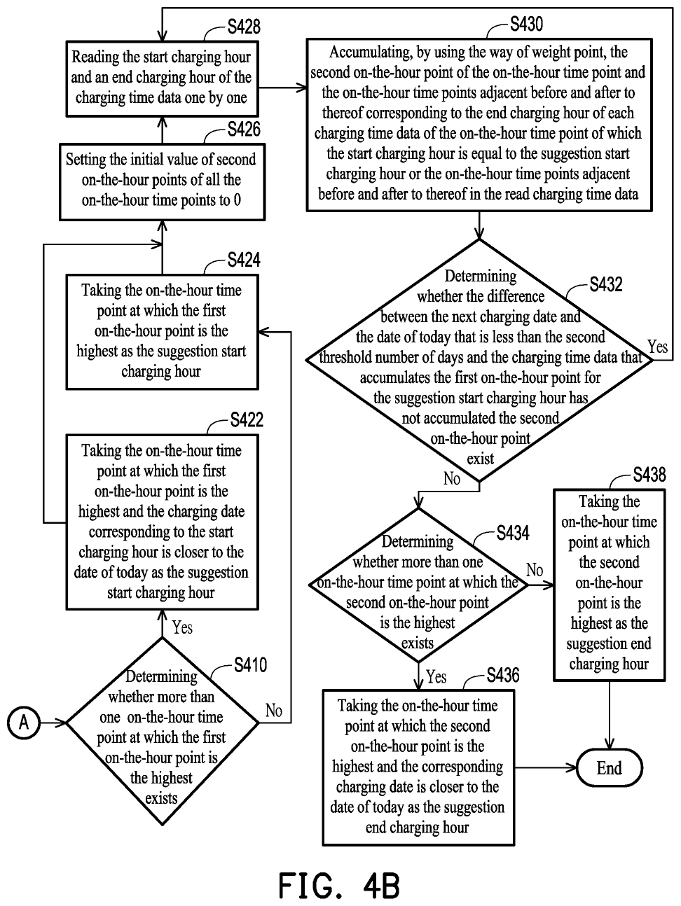

Another embodiment is given below to describe the detailed steps of obtaining the suggestion charging period RCT in the disclosure in more detail. Please refer to FIG. 1, FIG. 4A and FIG. 4B at the same time. The method of the embodiment is adapted for the device 100 for scheduling charging of FIG. 1, and the steps are described as follows.

The processor 120 first starts to analyze the suggestion start charging hour suitable for the user. In step S400 of FIG. 4A, the processor 120 sets the initial value of the analysis date to the date of today, sets the initial value of the first on-the-hour points of all on-the-hour time points to 0 and sets the initial value of the number of consecutive days without charging to 0.

In step S402, the processor 120 determines whether charging time data of which a charging date is equal to the analysis date exists in the extracted charging time data. When charging time data of which the charging date is equal to the analysis date exists, in step S404, the processor 120 reads the start charging hour of each charging time data of which the charging date is equal to the analysis date. In addition, the processor 120 further clears the number of consecutive days without charging to 0, so as to reset the number of consecutive days without charging.

Next, in step S406, the processor 120 accumulates, by using the way of weight point, the first on-the-hour point of the on-the-hour time point corresponding to each start charging hour that is read and the on-the-hour time points adjacent before and after to thereof. Specifically, the processor 120 may accumulate the first score (for example, 2 points) for the first on-the-hour point of the on-the-hour time point corresponding to the start charging hour of each charging time data of which the charging date is equal to the analysis date, and accumulate the second score (for example, 1 point) that is smaller than the first score for the first on-the-hour points of the on-the-hour time points adjacent before and after to the on-the-hour time point corresponding to the start charging hour of each charging time data of which the charging date is equal to the analysis date.

Next, in step S408, the processor 120 determines whether the first on-the-hour point of the on-the-hour time point exceeds a threshold value (for example, 10 points). If the first on-the-hour point of the on-the-hour time point exceeds the threshold value, the process proceeds to step S410 of FIG. 4B via step node A, so as to take the on-the-hour time point at which the first on-the-hour point is the highest as the suggestion start charging hour.

If no first on-the-hour point of the on-the-hour time point exceeds the threshold value, then in step S412 the processor 120 decrements the analysis date by one day. Next, in step S414, it is determined whether the difference between the analysis date and the date of today is greater than the second threshold number of days (for example, 30 days), and if so, analyzing the extracted charging time data is stopped, and the method of the embodiment ends. If not, the process goes back to step S402 to repeat step S402, step S404, step S406, step S408, step S412 and step S414, until the accumulation of the first on-the-hour point of the on-the-hour time point exceeds the threshold value or the difference between the analysis date and the date of today is greater than the second threshold number of days.

In addition, in step S402, when the processor 120 determines that no charging time data of which the charging date is equal to the analysis date exists, in step S416, the processor 120 increments the number of consecutive days without charging. Next, in step S418, the processor 120 determines whether the number of consecutive days without charging is greater than a first threshold number of days (for example, 3 days). If so, in step S420, the processor 120 clears the first on-the-hour points of all the on-the-hour time points to 0 to accumulate the first on-the-hour point again, and then the process proceeds to S412 to decrement the analysis date by one day. If not, the process proceeds directly to S412 to continue processing.

In step S410 of FIG. 4B, the processor 120 determines whether more than one on-the-hour time point at which the first on-the-hour point is the highest exists. If so, in step S422, the processor 120 takes the on-the-hour time point at which the first on-the-hour point is the highest and the charging date corresponding to the start charging hour is closer to the date of today as the suggestion start charging hour. If not, in step S424, the processor 120 takes the on-the-hour time point at which the first on-the-hour point is the highest as the suggestion start charging hour.

The processor 120 then begins to analyze the suggestion end charging hour suitable for the user. In step S426, the processor 120 sets the initial value of the second on-the-hour points of all the on-the-hour time points to 0.

In step S428, the processor 120 reads the start charging hour and the end charging hour of the charging time data one by one. Next, in step S430, the processor 120 accumulates, by using the way of weight point, the second on-the-hour point of the on-the-hour time point and the on-the-hour time points adjacent before and after to thereof corresponding to the end charging hour of each charging time data of the on-the-hour time point of which the start charging hour is equal to the suggestion start charging hour or the on-the-hour time points adjacent before and after to thereof in the read charging time data. Specifically, the processor 120 may filter out charging time data one by one from the read charging time data that the start charging hour is equal to the suggestion start charging hour or the on-the-hour time points adjacent before and after to thereof (that is, each charging time data that has accumulated the first on-the-hour point of the suggestion start charging hour). Next, the processor 120 may accumulate the first score (for example, 2 points) for the second on-the-hour point corresponding to the end charging hour of each charging time data that has been screened out, and accumulate the second score (for example, 1 point) that is smaller than the first score for the second on-the-hour point of the on-the-hour time point corresponding to the end charging hour of each charging time data that has been screened out and the on-the-hour time points adjacent before and after to thereof. Different from when analyzing the suggestion start charging hour, continuing to read the charging time data for the previous day is not required when the second on-the-hour point does not exceed the threshold value, and considering the number of consecutive days without charging is also not required. Merely analyzing each of the charging time data that has accumulated the first on-the-hour point of the suggestion start charging hour is required to accumulate the second on-the-hour point of the corresponding on-the-hour time point.

Next, in step S432, the processor 120 determines whether the difference between the next charging date and the date of today that is less than the second threshold number of days and the charging time data that accumulates the first on-the-hour point for the suggestion start charging hour has not accumulated the second on-the-hour point exist. If not, the process proceeds to step S434, so as to take the on-the-hour time point at which the second on-the-hour point is the highest as the suggestion end charging hour. If the next charging time data has not yet accumulated the second on-the-hour point, then the process returns to step S428 to continue the processing.

In step S434, the processor 120 determines whether more than one on-the-hour time point at which the second on-the-hour point is the highest exists. If so, in step S436, the processor 120 takes the on-the-hour time point at which the second on-the-hour point is the highest and the corresponding charging date is closer to the date of today as the suggestion end charging hour. If not, in step S438, the processor 120 takes the on-the-hour time point at which the second on-the-hour point is the highest as the suggestion end charging hour.

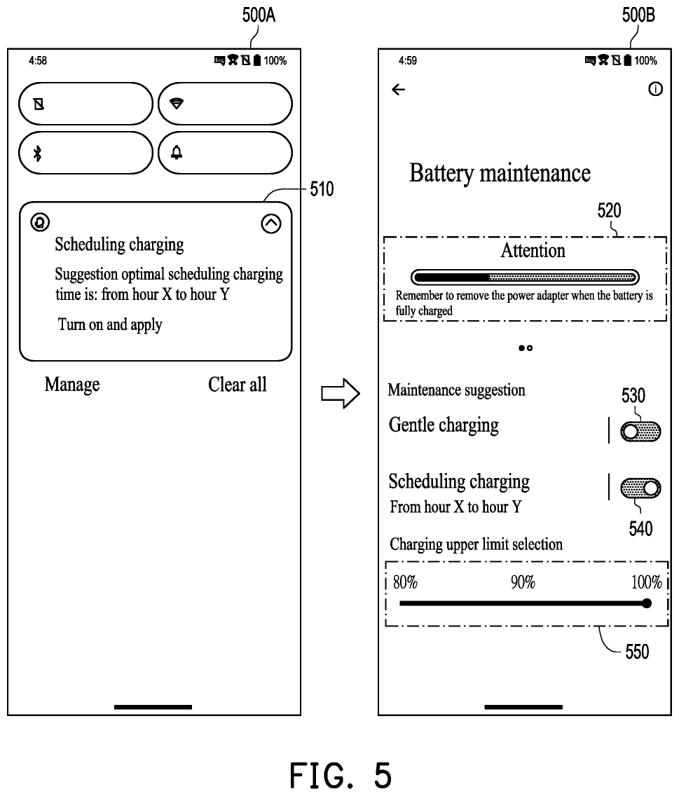

In an embodiment, after the processor 120 obtains the suggestion charging period RCT, the notification device 130 may, for example, at the time of the next day before the first predetermined time (for example, half an hour) of the suggestion start charging hour of the suggestion charging period RCT, notify the user of the suggestion charging period RCT through the notification screen. For example, FIG. 5 shows examples of notification screens 500A and 500B. The notification device 130 may firstly display the notification screen 500A. A notification window 510 is provided on the notification screen 500A. In the notification window 510, the text “suggestion optimal scheduling charging time is from hour X to hour Y” may be displayed, and X and Y may correspond to the suggestion charging period RCT.

The notification window 510 may be clicked by the user. When the user clicks the notification window 510, the notification device 130 switches to display the notification screen 500B. In the notification screen 500B, charging status prompt information 520 is provided, which may display how long the battery 140 is fully charged. When the power adapter is still connected after a full charge for more than a predetermined time, text or colors to be noticed are displayed to remind the user to remember to remove the power adapter. For example, if the power adapter is still plugged in for more than 16 hours after being fully charged, the charging status prompt information 520 displays the text “Attention” and the pattern is displayed in red. If the power adapter is removed after full charging, the charging status prompt information 520 displays the text “Good” and the pattern is displayed in green. In addition, the notification screen 500B further has a switch icon 530 for a gentle charging function, a switch icon 540 for the scheduling charging function and a setting icon 550 for setting the charging upper limit.

The gentle charging function, for example, enables charging at a gentle rate to protect the battery. The scheduling charging function, for example, allows the processor 120 to stop charging and recharge the battery when the device 100 for scheduling charging is scheduled to enter the power-on state (such as the state where the power adapter is plugged in) during the suggestion charging period RCT, so that the power of the battery 140 is maintained at a predetermined percentage (e.g., 80%) before the second predetermined time (e.g., 2 hours) of the suggestion end charging hour. recommended to end charging. For example, when the scheduling charging function is turned on, if the power adapter is plugged into the device 100 for scheduling charging, the processor 120 checks whether the current time falls in the period that is 2 hours before the suggestion start charging hour and the suggestion end charging hour. If so, the processor 120 starts the scheduling charging to keep the power of the battery 140 at 80% until 2 hours before the suggestion end charging hour. If not, the processor 120 waits until after the suggestion start charging hour before performing the scheduling charging.

During the scheduling charging period, if the power of the battery 140 is less than 80%, charging is performed normally. After the power of the battery 140 is greater than or equal to 80%, charging stops. When charging stops, if the power of the battery 140 is less than 80% to a certain extent (for example, the power is reduced to 70%), recharging is performed until the power is greater than or equal to 80%, and then charging stops. When charging stops, if the current time is more than 2 hours before the suggestion end charging hour, recharging is performed and then the power is fully charged to 100% before the end of the scheduling charging period.

Through the above operations, the device 100 for scheduling charging may dynamically adjust the charging intensity within the scheduling charging period (the suggestion charging period RCT), so as to prevent the battery 140 from maintaining the full charging state for a long time, and at the same time avoid the condition that the battery 140 cannot be fully charged within the predetermined charging period.

To sum up, the method and the device for scheduling charging of the disclosure can collect charging records of the user. After collecting enough charging records, the charging habits of the user are analyzed to accurately predict the suggestion charging period suitable for the user, and then the suggestion charging period is provided to the user through the notification interface (the notification device). In this way, when charging is performed during the scheduling suggestion charging period, the charging intensity can be dynamically adjusted to prevent the battery from maintaining the full charging state for a long time, thereby preventing damage to the battery and increasing the service life of the battery.

What is claimed is:

1. A method for scheduling charging, comprising:
collecting a plurality of charging records;
extracting a plurality of charging time data of the charging records of which charging duration is within a predetermined time range from the charging records that are collected; and
analyzing the charging time data by using a way of weight point to obtain a suggestion charging period.

2. The method for scheduling charging according to claim 1, wherein the suggestion charging period comprises a suggestion start charging hour and a suggestion end charging hour, each of the charging time data comprises a charging date, a start charging hour and an end charging hour, time of a day comprises a plurality of on-the-hour time points, and analyzing the charging time data by using the way of weight point to obtain the suggestion charging period comprises:
accumulating, by using the way of weight point, a first on-the-hour point of the on-the-hour time point corresponding to the start charging hour of each of the charging time data according to the charging date and the start charging hour of each of the charging time data;
taking the on-the-hour time point at which the first on-the-hour point is the highest as the suggestion start charging hour;
accumulating, by using the way of weight point, a second on-the-hour point of the on-the-hour time point corresponding to the end charging hour of each of the charging time data according to the charging date, the start charging hour and the end charging hour of each of the charging time data; and
taking the on-the-hour time point at which the second on-the-hour point is the highest as the suggestion end charging hour.

3. The method for scheduling charging according to claim 2, wherein accumulating, by using the way of weight point, the first on-the-hour point of the on-the-hour time point corresponding to the start charging hour of each of the charging time data according to the charging date and the start charging hour of each of the charging time data comprises:
setting an initial value of an analysis date to a date of today, and setting an initial value of the first on-the-hour point of all the on-the-hour time points to 0;
reading the start charging hour of each of the charging time data of which the charging date is equal to the analysis date;
accumulating, by using the way of weight point, the first on-the-hour point of the on-the-hour time point corresponding to each of the start charging hour and the on-the-hour time points adjacent before and after to thereof;
determining whether the first on-the-hour point of the on-the-hour time point exceeds a threshold value;
if so, taking the on-the-hour time point at which the first on-the-hour point is the highest as the suggestion start charging hour; and
if not, repeating a decrement in the analysis date by one day, reading of the start charging hour of each of the charging time data of which a charging date is equal to the analysis date, accumulation, by using the way of weight point, of the first on-the-hour point of the on-the-hour time point corresponding to each of the start charging hours that are read and the on-the hour time points adjacent before and after to thereof, and determination of whether the first on-the-hour point of the on-the-hour time point exceeds the threshold value, until the accumulation of the first on-the-hour point of the on-the-hour time point exceeds the threshold value.

4. The method for scheduling charging according to claim 3, wherein accumulating, by using the way of weight point, the first on-the-hour point of the on-the-hour time point corresponding to each of the start charging hour and the on-the-hour time points adjacent before and after to thereof comprises:
accumulating a first score for the first on-the-hour point of the on-the-hour time point corresponding to the start charging hour of each of the charging time data of which the charging date is equal to the analysis date; and
accumulating a second score that is smaller than the first score for the first on-the-hour point of the on-the-hour time points adjacent before and after to the on-the-hour time point corresponding to the start charging hour of each of the charging time data of which the charging date is equal to the analysis date.

5. The method for scheduling charging according to claim 3, wherein before reading the start charging hour of each of the charging time data of which the charging date is equal to the analysis date, further comprises:
setting an initial value of a number of consecutive days without charging to 0;
determining whether the charging time data of which the charging date is equal to the analysis date exists;
when no charging time data of which the charging date is equal to the analysis date exists, incrementing the number of consecutive days without charging, and determining whether the number of consecutive days without charging is greater than a first threshold number of days;
if so, clearing the first on-the-hour point of all the on-the-hour time points to 0, and decrementing the analysis date by one day;
if not, decrementing the analysis date by one day; and
when the charging time data of which the charging date is equal to the analysis date exists, clearing the number of consecutive days without charging to 0.

6. The method for scheduling charging according to claim 3, further comprising:
determining whether difference between the analysis date and the date of today is greater than a second threshold number of days; and
if so, stopping analyzing the charging time data.

7. The method for scheduling charging according to claim 2, wherein taking the on-the-hour time point at which the first on-the-hour point is the highest as the suggestion start charging hour comprises:
determining whether more than one of the on-the-hour time points at which the first on-the-hour point is the highest exists; and
if so, taking the on-the-hour time point at which the first on-the-hour point is the highest and the charging date of the corresponding start charging hour is closer to a date of today as the suggestion start charging hour.

8. The method for scheduling charging according to claim 2, wherein accumulating, by using the way of weight point, the second on-the-hour point of the on-the-hour time point corresponding to the end charging hour of each of the charging time data according to the charging date, the start charging hour and the end charging hour of each of the charging time data comprises:
setting an initial value of the second on-the-hour point for all the on-the-hour time points to 0;
reading the start charging hour and the end charging hour of the charging time data one by one; and
accumulating, by using the way of weight point, the second on-the-hour point of the on-the hour time point and the on-the-hour time points adjacent before and after to thereof corresponding to the end charging hour of each of the charging time data of the on-the-hour time point of which the start charging hour is equal to the suggestion start charging hour or the on-the-hour time points adjacent before and after to thereof in the charging time data that is read.

9. The method for scheduling charging according to claim 2, further comprising:
notifying the suggestion charging period at a time before a first predetermined time of the suggestion start charging hour that is obtained.

10. The method for scheduling charging according to claim 2, further comprising:
when a power-on state is entered during the suggestion charging period, maintaining power of a battery at a predetermined percentage before a second predetermined time of the suggestion end charging hour.

11. The method for scheduling charging according to claim 2, wherein taking the on-the-hour time point at which the second on-the-hour point is the highest as the suggestion end charging hour comprises:
determining whether more than one of the on-the-hour time points at which the second on-the-hour point is the highest exists; and
if so, taking the on-the-hour time point at which the second on-the-hour point is the highest and the charging date of the corresponding end charging hour is closer to a date of today as the suggestion end charging hour.

12. A device for scheduling charging, comprising:
a memory, storing a module group; and
a processor, coupled to the memory, and loading and executing the module group stored in the memory for:
collecting a plurality of charging records;
extracting a plurality of charging time data of the charging records of which charging duration is within a predetermined time range from the charging records that are collected; and
analyzing the charging time data by using a way of weight point to obtain a suggestion charging period.

13. The device for scheduling charging according to claim 12, wherein the suggestion charging period comprises a suggestion start charging hour and a suggestion end charging hour, each of the charging time data comprises a charging date, a start charging hour and an end charging hour, and time of a day comprises a plurality of on-the-hour time points,
the processor accumulates, by using the way of weight point, a first on-the-hour point of the on-the-hour time point corresponding to the start charging hour of each of the charging time data according to the charging date and the start charging hour of each of the charging time data,
the processor takes the on-the-hour time point at which the first on-the-hour point is the highest as the suggestion start charging hour,
the processor accumulates, by using the way of weight point, a second on-the-hour point of the on-the-hour time point corresponding to the end charging hour of each of the charging time data according to the charging date, the start charging hour and the end charging hour of each of the charging time data,
the processor takes the on-the-hour time point at which the second on-the-hour point is the highest as the suggestion end charging hour.

14. The device for scheduling charging according to claim 13, wherein the processor sets an initial value of an analysis date to a date of today, and sets an initial value of the first on-the-hour point of all the on-the-hour time points to 0,
the processor reads the start charging hour of each of the charging time data of which the charging date is equal to the analysis date,
the processor accumulates, by using the way of weight point, the first on-the-hour point of the on-the-hour time point corresponding to each of the start charging hour and the on-the-hour time points adjacent before and after to thereof,
the processor determines whether the first on-the-hour point of the on-the-hour time point exceeds a threshold value,
if so, the processor takes the on-the-hour time point at which the first on-the-hour point is the highest as the suggestion start charging hour,
if not, the processor repeats a decrement in the analysis date by one day, reading of the start charging hour of each of the charging time data of which a charging date is equal to the analysis date, accumulation, by using the way of weight point, of the first on-the-hour point of the on-the-hour time point corresponding to each of the start charging hours that are read and the on-the hour time points adjacent before and after to thereof, and determination of whether the first on-the-hour point of the on-the-hour time point exceeds the threshold value, until the accumulation of the first on-the-hour point of the on-the-hour time point exceeds the threshold value.

15. The device for scheduling charging according to claim 14, wherein the processor accumulates a first score for the first on-the-hour point of the on-the-hour time point corresponding to the start charging hour of each of the charging time data of which the charging date is equal to the analysis date,
the processor accumulates a second score that is smaller than the first score for the first on-the-hour point of the on-the-hour time points adjacent before and after to the on-the-hour time point corresponding to the start charging hour of each of the charging time data of which the charging date is equal to the analysis date.

16. The device for scheduling charging according to claim 14, wherein the processor sets an initial value of a number of consecutive days without charging to 0,
the processor determines whether the charging time data of which the charging date is equal to the analysis date exists,
when no charging time data of which the charging date is equal to the analysis date exists, the processor increments the number of consecutive days without charging, and determines whether the number of consecutive days without charging is greater than a first threshold number of days,
if so, the processor clears the first on-the-hour point of all the on-the-hour time points to 0, and decrements the analysis date by one day,
if not, the processor decrements the analysis date by one day,
when the charging time data of which the charging date is equal to the analysis date exists, the processor clears the number of consecutive days without charging to 0.

17. The device for scheduling charging according to claim 14, wherein the processor determines whether difference between the analysis date and the date of today is greater than a second threshold number of days,
if so, the processor stops analyzing the charging time data.

18. The device for scheduling charging according to claim 13, wherein the processor determines whether more than one of the on-the-hour time points at which the first on-the-hour point is the highest exists,
if so, the processor takes the on-the-hour time point at which the first on-the-hour point is the highest and the charging date of the corresponding start charging hour is closer to a date of today as the suggestion start charging hour.

19. The device for scheduling charging according to claim 13, wherein the processor sets an initial value of the second on-the-hour point of all the on-the-hour time points to 0,
the processor reads the start charging hour and the end charging hour of the charging time data one by one,
the processor accumulates, by using the way of weight point, the second on-the-hour point of the on-the hour time point and the on-the-hour time points adjacent before and after to thereof corresponding to the end charging hour of each of the charging time data of the on-the-hour time point of which the start charging hour is equal to the suggestion start charging hour or the on-the-hour time points adjacent before and after to thereof in the charging time data that is read.

20. The device for scheduling charging according to claim 13, further comprising:
a notification device, coupled to the processor, and notifying the suggestion charging period at a time before a first predetermined time of the suggestion start charging hour that is obtained.

21. The device for scheduling charging according to claim 13, further comprising:
a battery, coupled to the processor,
when a power-on state is entered during the suggestion charging period, the processor maintains power of the battery at a predetermined percentage before a second predetermined time of the suggestion end charging hour.

22. The device for scheduling charging according to claim 13, wherein the processor determines whether more than one of the on-the-hour time points at which the second on-the-hour point is the highest exists,
if so, the processor takes the on-the-hour time point at which the second on-the-hour point is the highest and the charging date of the corresponding end charging hour is closer to a date of today as the suggestion end charging hour.
